(19) United States
(12) Patent Application Publication
(10) Pub. No.: US 2025/0356068 A1
(43) Pub. Date: Nov. 20, 2025

(54) JACKING FORCE PREDICTION METHOD FOR WHOLE CONSTRUCTION PROCESS BY VERTICAL JACKING METHOD

(71) Applicant: HANGZHOU CITY UNIVERSITY, Hangzhou (CN)

(72) Inventors: Xinjiang WEI, Hangzhou (CN); Shuyuan ZHANG, Hangzhou (CN); Xiao WANG, Hangzhou (CN); Zihai YAN, Hangzhou (CN); Zhi DING, Hangzhou (CN); Liangliang LU, Hangzhou (CN); Jiajia YAN, Hangzhou (CN)

(21) Appl. No.: 18/866,983

(22) PCT Filed: Aug. 3, 2022
(86) PCT No.: PCT/CN2022/109871

§ 371 Date: Nov. 18, 2024

(30) Foreign Application Priority Data
May 17, 2022 (CN) 202210537822.8

(51) Int. Cl. G06F 30/13

(52) U.S. Cl. CPC G06F 30/13

(57) ABSTRACT

A jacking force prediction method for a whole construction process by a vertical jacking method, based on a spherical hole expansion theory and a shear failure principle, uses two jacking force calculation models. The models include a spherical hole expansion-sliding friction model and a shear failure-sliding friction model, and corresponding calculation formulas are deduced. When an overlying soil layer is high and the jacking force calculated by adopting the spherical hole expansion-sliding friction model is relatively small, a spherical hole expansion problem occurs at a vertical pipe cover. When the overlying soil layer is relatively low and the jacking force calculated by adopting the shear failure-sliding friction model is relatively small, a soil body failure form at the vertical pipe cover is shear failure.

### FIELD OF THE INVENTION

The present invention belongs to the technical field of underground tunnel engineering and relates to a jacking force prediction method for a whole construction process by a vertical jacking method.

### BACKGROUND OF THE INVENTION

With the rapid economic growth in China, there are an increasing number of water intake and drainage projects such as large thermal power plants and nuclear power plants in coastal areas; moreover, the construction of underground projects such as urban pipelines often encounters many construction problems such as ventilation and maintenance shafts. Under this background, the vertical jacking method has been widely used due to its advantages of short construction period, small impact on the environment and high efficiency, etc.

In the construction of the vertical jacking method, the determination of the jacking force, especially the determination of the maximum jacking force is particularly important, which is not only related to the feasibility of jacking and the stability of the horizontal tunnel, but also involves the measures such as the design of jacking pipe sections, reinforcement of tunnel bottom and whether upper soil needs to be excavated to reduce drag. When the jacking force is too large, it may cause deformation and cracking of the jacking vertical pipe and instability of the horizontal tunnel. When the jacking force is too small, jacking will be impossible. Therefore, it is necessary to conduct a systematic study on the jacking force of the vertical jacking method. However, there are currently few studies on the calculation of jacking force and the dynamic change rules of jacking force.

Most studies on the vertical jacking method at home and abroad focus on the construction technologies and water-stopping measures. The calculation of the jacking force is mostly based on experience and is not very theoretical. At present, there are mainly two methods to calculate the jacking force, one is the method proposed by Wang Shousheng et al. It is assumed that the top of the shear failure line is calculated by 1.2D−1.5D (D is the outer diameter of the vertical pipe). The jacking force consists of five parts: water weight, soil weight within the failure line, self-weight of the jacked pipe, shear force between the pipe and soil, and friction during jacking; the other is the empirical algorithm recommended by the Shanghai Pipe Jacking Engineering Construction Code^{[2]}, which provides the calculation formula of the maximum jacking force, and considers that the jacking force is the largest when jacking the first pipe section, wherein the soil-breaking force is considered to be the largest component affecting the jacking force. Empirical values are given for sand and clay respectively. The above methods have the following shortcomings:
1) in actual engineering cases, the maximum jacking force does not occur at the initial jacking, but generally occurs during the jacking process;
2) it is not specified whether the value is 1.2 or 1.5 in Wang Shousheng's algorithm;
3) most of them are empirical values and the theory is slightly insufficient.

In the vertical jacking method, the vertical pipe is constantly jacked upward, and the resistance of the soil to the vertical pipe is also changing constantly, so the jacking force changes dynamically. Therefore, according to its construction characteristics, it is necessary to consider the changes in the thickness of the overlying soil and re-propose a jacking force prediction method for the whole construction process by the vertical jacking method.

### SUMMARY OF THE INVENTION

An object of the present invention is to provide a jacking force prediction method for a whole construction process by a vertical jacking method in view of the shortcomings in the prior art, which can estimate the jacking force required in the construction more accurately and dynamically. To achieve this object, the present invention adopts the following technical solutions:
A jacking force prediction method for a whole construction process by a vertical jacking method is characterized by including the following steps:
step 1, determining a component part of a jacking force in constructing by the vertical jacking method;
the jacking force F of the vertical jacking method is matched according to the three parts, namely, a head resistance F_{y}, a friction force F_{f} between a pipe and soil and the pipe self weight Gₚ; the head resistance F_{y} is the sum of stress at a vertical pipe cover, namely, F=F_{yb}+F_{f}+Gₚ;
step 2, selecting a stress model in the jacking process of the vertical pipe, and calculating the head resistance F_{y};
according to the thickness of an overlying soil layer, the stress of head resistance is divided into two stress models, namely a spherical hole expansion-sliding friction model and a shear failure-sliding friction model; when the overlying soil layer is higher, and if F_{yb}<F_{ys}, a spherical hole expansion problem occurs at the vertical pipe cover, then F_{y}=F_{yb}=πPᵤR_{d}²; and when the overlying soil layer is lower, and if Fys<Fyb, a soil body failure form at the vertical pipe cover is shear failure, and then F_{y}=F_{ys}=Gₛ+Gₛ+F_{c}f; Gₛ represents soil weight (kN) in a shear failure line, Gₛ=γ′πh [R_{d}²+Rₘ²+R_{d}Rₘ]/3 and Rₘ=R_{d}+htan(45°−φ/2); G_{w} represents water weight (kN) in the range of the vertical pipe, G_{w}=γ_{w}πR_{d}²H; F_{cf} represents resistance (kN) caused by the cohesive force of the soil body in the shear failure line, F_{cf}=cπ(R_{d}+Rₘ\sqrt{(Rₘ−R_{d})²+h²}; and F_{yb} represents head resistance (kN) under a spherical hole expansion-sliding friction model; F_{ys} Pu represents head resistance (kN) under a shear failure-sliding friction model; Pᵤ represents ultimate reaming pressure (kPa); R_{d} represents the radius (m) of the vertical pipe; γ′ represents effective weight (kN·m⁻³) of the soil body; h represents the height (m) from the vertical pipe pipe cover to a mud surface line; Rₘ represents distance (m) from the shear failure line extending to the mud surface line to the center of the vertical pipe; γ_{w} represents water weight (kN·m⁻³); H represents height (m) from the upper side of a horizontal tunnel to the mud surface line; and c represents cohesive force (kPa);
Step 3, calculating the jacking force according to the calculated F=Fy +F? +Gp. Further, the value of the friction force Fr between the pipe and soil is calculated according to the following formula: F_{f}=μKπDL²[γ′h+γ_{w}h+γ_{w l (H+h)/}2]. μ represents a friction coefficient between the pipe and the soil, K represents lateral soil pressure coefficient, and D represents outer diameter (m) of the vertical pipe.

Further, the value of self weight Gp of the pipe is calculated according to the following formula: Gₚ=nG′; n represents the number of jacked pipe sections; and G′ represents average self weight (kN) of the pipe sections.

According to the present invention, the influence of dynamic changes of the thickness of overlaying soil on head resistance is considered, a more objective and comprehensive theoretical basis is achieved, and the jacking force of the whole construction process by the vertical jacking method can be estimated more accurately.

### BRIEF DESCRIPTION OF THE DRAWINGS

FIG. 1 is a force diagram of a vertical pipe during the construction by a vertical jacking method.

FIG. 2 is a force diagram of a spherical hole expansion-sliding friction vertical pipe.

FIG. 3 is a force diagram of a shear failure-sliding friction vertical pipe.

FIG. 4 is a schematic diagram of a basic problem of spherical hole expansion.

FIG. 5 is a flow chart for solving a jacking force.

FIG. 6 is a comparison chart of jacking force results of the first group of vertical pipes.

FIG. 7 is a comparison chart of jacking force results of the second group of vertical pipes.

### DETAILED DESCRIPTION

A jacking force calculation method for a whole construction process by a vertical jacking method provided by the present invention will be described in detail below in conjunction with the logical thinking process in the research.
Step 1: Determining of a component part of a jacking force in constructing by a vertical jacking method

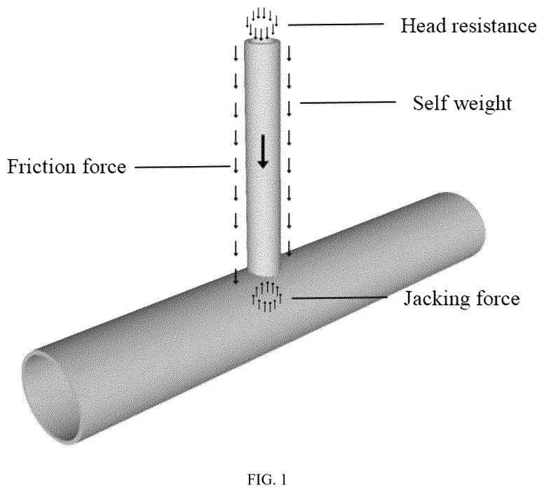

In the constructing by the vertical jacking method, it is needed to overcome the resistance from each of the upper layers to smoothly jack out a vertical pipe, which is similar to stress analysis in horizontal pipe jacking construction engineering; the jacking force of the vertical jacking method is matched with three corresponding parts (see FIG. 1); the vertical pipe mainly bears: \textcircled{1}head resistance F_{y}; \textcircled{2}) friction force Ff between the pipe and soil; and 3 self weight Gₚ of the pipe. The head resistance is the sum of stress at a vertical pipe cover, and is also the key content of the research in the present invention.
Step 2: Establishing a stress model in the jacking process of the vertical pipe

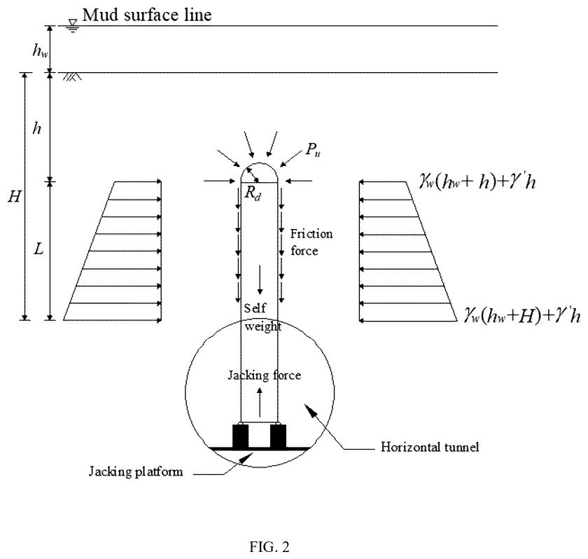

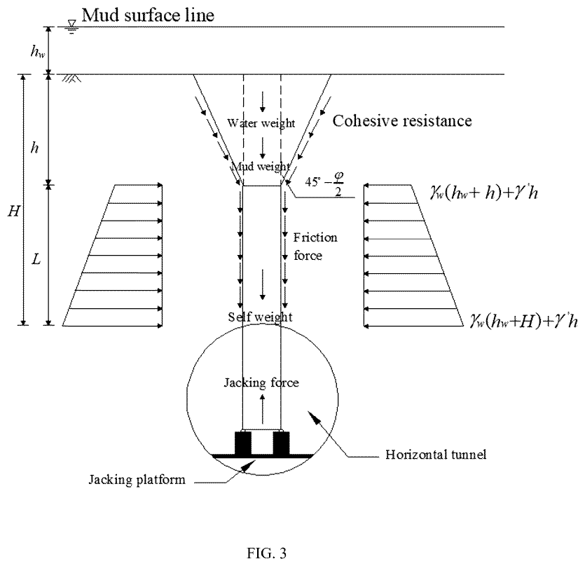

According to construction characteristics, the stress mechanism of the head resistance is related to the height of an overlying soil layer; the vertical jacking process can be regarded as the spherical hole expansion problem when the overlying soil layer is high, and the soil body failure form is shear failure when the overlying soil layer is shallow. On basis of that, two jacking force calculation models are proposed; when the overlying soil layer is higher than a threshold value, the vertical jacking process can be regarded as the spherical hole expansion problem, and the spherical hole expansion-sliding friction model is adopted (FIG. 2); when the overlying soil layer is lower than the threshold value, the soil body failure form is the shear failure, and the shear failure-sliding friction model is adopted (FIG. 3); and aiming at the two models, the following assumptions are made:
(1) the initial radius of the spherical hole expansion-sliding friction model is assumed to be 0, the final reaming radius is the radius of thee vertical pipe, and the included angle between a failure line and the vertical direction of the shear failure-sliding friction model is assumed to be 45°−φ/2; (2) when the jacking force value calculated by the spherical hole expansion-sliding friction model is smaller than that of the shear failure-sliding friction model, spherical hole expansion yield occurs in the vertical jacking process, otherwise only the shear failure occurs; (3) during initial jacking, the initial value of the head resistance is taken as the water and soil pressure in the range of the vertical pipe, and in the jacking process from the initial jacking to the maximum head resistance, the head resistance is linearly changed along with the jacking distance, and the position with the maximum head resistance occurs at the compression amount of the overlying soil layer; and (4) the contact between the vertical pipe and the soil is “full contact”, namely the contact between the pipe and the soil is full.
Step 3: Establishing a calculation formula of each component of jacking force
(I) Head resistance Fyb of spherical hole expansion-sliding friction model

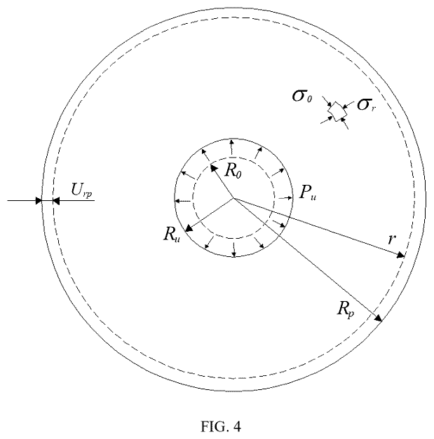

The basic problem of spherical hole expansion is shown in FIG. 4, and a balance equation, a geometric equation and a physical equation are respectively shown as follows:

$$d {σ}_{r} / dr + 2 ( {σ}_{r} - {σ}_{θ} ) / r = 0 \qquad ( 1 )$$

$$\{ \begin{matrix}{ε}_{r} = - {du}_{r} / dr \\ {ε}_{θ} = - {u}_{r} / r\end{matrix} \qquad ( 2 )$$

$$\{ \begin{matrix}{ε}_{r} = ( {σ}_{r} - 2 v {σ}_{θ} ) / E \\ {ε}_{θ} = [ ( 1 - v ) {σ}_{θ} - v {σ}_{r} ] / E\end{matrix} \qquad ( 3 )$$

in the formulas, σᵣ , and σ₇₄ respectively represent radial and tangential stresses, u,ᵣ represents radial displacement, v represents Poisson's ratio, and E represents elastic modulus;

according to boundary conditions,

$$\{ \begin{matrix}{σ}_{r} \vert ( r = {R}_{p} ) = {σ}_{p} \\ {σ}_{r} \vert ( r \to ∞ ) = {P}_{0} \\ {σ}_{r} \vert ( r = {R}_{u} ) = {P}_{u}\end{matrix} \qquad ( 4 )$$

in the formula, Rₚ represents the radius of a plastic zone, Rᵤ represents the final reaming radius, and it is D/2 herein; σₚ represents critical plastic reaming pressure; P₀ represents initial hole pressure; Pᵤ represents ultimate reaming pressure; and

the soil stress and displacement solution of an elastic zone may be solved:

$$\{ \begin{matrix}{σ}_{r} = {P}_{0} + ( {σ}_{p} - {P}_{0} ) {( \frac{{R}_{p}}{r} )}^{3} \\ {σ}_{θ} = {P}_{0} - \frac{1}{2} ( {σ}_{p} - {P}_{0} ) {( \frac{{R}_{p}}{r} )}^{3} \\ {u}_{r} = \frac{{σ}_{p} - {P}_{0}}{4 G} {( \frac{{R}_{p}}{r} )}^{3} r\end{matrix} \qquad ( 5 )$$

In the formula, G represents shear modulus.

If the soil yield meets the Mohr-Coulomb strength yield criterion, then:

$${σ}_{r} - {σ}_{θ} = ( {σ}_{r} + {σ}_{θ} ) sin φ + 2 c cos φ \qquad ( 6 )$$

In the formula, c represents cohesive force, and o represents an internal friction angle;

In combination with the boundary conditions, then:

$${σ}_{r} = ( {P}_{u} + c cot φ ) {( \frac{{R}_{u}}{r} )}^{\frac{4 sin φ}{1 + sin φ}} - c cot φ \qquad ( 7 )$$

At the elastic-plastic stress boundary, the soil can simultaneously meet the elastic zone boundary condition and the plastic zone boundary condition, and thus the stress expression at the elastic-plastic boundary can be obtained as follows:

$${σ}_{p} = \frac{4 {P}_{0} sin φ + 4 c cos ϕφ}{3 - sin φ} + {P}_{0} \qquad ( 8 )$$

If r=Rᵤ, the formula (7) and the formula (8) are combined, then:

$${P}_{u} = \frac{3 + 3 sin φ}{3 - sin φ} ( {P}_{0} + c cot φ ) {λ}^{\frac{4 sin φ}{1 + sin φ}} - c cot φ \qquad ( 9 )$$

In the formula:λ=Rₚ/Rᵤ.

The annular strain ϵ_{θp} and radial displacement uᵣₚ at the elastic-plastic boundary can be expressed as follows:

$${ε}_{θ p} = ( {P}_{0} + c cot φ ) \frac{sin φ}{G ( 3 - sin φ )} \qquad ( 10 )$$

$${u}_{rp} = \frac{{σ}_{p} - {P}_{0}}{4 G} {R}_{p} \qquad ( 11 )$$

For plastic deformation, the radial displacement of the plastic zone can be deduced by Carter^{[3]} and expressed as follows:

$${u}_{r} = {ε}_{θ p} [ {A ( \frac{{R}_{p}}{r} )}^{1 + α} + {B ( \frac{{R}_{p}}{r} )}^{1 - β} + T ] r \qquad ( 20 )$$

$$T = 1 - A + B \qquad ( 13 )$$

$$A = \frac{Z + 3}{1 + α} \qquad ( 14 )$$

$$B = \frac{Z}{1 - β} \qquad ( 15 )$$

$$α = \frac{2 ( 1 - sin ψ )}{1 + sin ψ} \qquad ( 16 )$$

$$β = \frac{1 - 3 sin φ}{1 + sin φ} \qquad ( 17 )$$

$$Z = \frac{6 S}{α + β} \qquad ( 18 )$$

$$S = \frac{2 ( 1 - v ) - 2 v ( M + N ) + M N}{( 1 + v ) M N} \qquad ( 19 )$$

$$M = \frac{2}{α} \qquad ( 20 )$$

$$N = \frac{2}{1 + β} \qquad ( 21 )$$

In the formula, Ψ is a shear expansion angle; and α, β, A, B, T, Z, S, M and N are all dimensionless intermediate parameters.

In order to solve the radius of the plastic zone, the volume strain Δ of the plastic zone is introduced:

$$Δ = \frac{{\int }_{{R}_{u}}^{{R}_{p}} 4 π {r}^{2} ( {ε}_{r} + 2 {ε}_{θ} ) d r}{\frac{4}{3} π ( {R}_{p}^{3} - {R}_{u}^{3} )} \qquad ( 22 )$$

The formula (2) and the formula (12) are combined as follows:

$$Δ = 3 {ε}_{θ p} \frac{{λ}^{3} - A {λ}^{1 + α} - B {λ}^{1 - β} - S}{{λ}^{3} - 1} \qquad ( 23 )$$

It is the ratio of the volume change to the total volume of the plastic zone, and before and after hole expansion, according to volume conservation, it is:

$${R}_{u}^{3} - {R}_{0}^{3} = {R}_{p}^{3} - {( {R}_{p} - {u}_{r p} )}^{3} + Δ ( {R}_{p}^{3} - {R}_{u}^{3} ) \qquad ( 24 )$$

uᵣₚ higher order item is ignored in expansion, and it is substituted into Formula (11):

$$Δ = \frac{1 - {( \frac{{R}_{0}}{{R}_{u}} )}^{3} - 3 {λ}_{{ε}_{θ p}}^{3}}{{λ}^{3} - 1} \qquad ( 25 )$$

Therefore, the radius of the plastic zone can be solved, the specific solving process is shown as follows:
1) measuring each parameter of a soil body according to an experiment, and determining values of various parameters c, Φ, Ψ, μ, E and G;
2) determining dimensionless intermediate parameters α, β, A, B, T and S according to the parameters of the soil body; and
3) solving a transcendental equation through matlab software by combining Formulas (22) and (25), solving 2, and further solving Rₚ.

The value of the head resistance Fyb of the spherical hole expansion-sliding friction model is shown as follows:

$${F}_{y b} = π {P}_{u} {R}_{d}^{2} \qquad ( 26 )$$

In the formula, R_{d} represents the radius of the vertical pipe.
(II) Head resistance Fys of shear failure-sliding friction model

As shown in FIG. 3, F_{ys} is calculated through the following formula:

$${F}_{y s} = {G}_{s} + {G}_{w} + {F}_{c f} \qquad ( 27 )$$

$${G}_{s} = {γ}^{′} π h [ {R}_{d}^{2} + {R}_{m}^{2} + {R}_{d} {R}_{m} ] / 3 \qquad ( 28 )$$

$${R}_{m} = {R}_{d} + h tan ( 45 ° - φ / 2 ) \qquad ( 29 )$$

$${G}_{w} = {γ}_{w} π {R}_{d}^{2} H \qquad ( 30 )$$

$${F}_{c f} = c π ( {R}_{d} + {R}_{m} ) \sqrt{{( {R}_{m} - {R}_{d} )}^{2} + {h}^{2}} \qquad ( 31 )$$

In the formula, γ′ represents effective weight, and γ_{w} represents water weight.
III) Friction force F_{f} between pipe and soil

The friction force between the pipe and soil is related to the jacking distance and can be calculated generally according to the following formula:

$${F}_{f} = μ K π D {L}^{2} [ {γ}^{′} h + {γ}_{w} ( {h}_{w} + \frac{H + h}{2} ) ] \qquad ( 32 )$$

In the formula:μ represents the friction coefficient between the pipe and the soil, K represents the lateral soil pressure coefficient, and the value can be K=1−sinΦ.
(IV) Pipe self weight Gₚ

The vertical pipe self weight is related to the jacking pipe sections and is calculated according to the following formula:

$${G}_{p} = {nG}^{′} \qquad ( 33 )$$

In the formula, n represents the number of jacked pipe sections, and G′ represents the average pipe section weight.
Step 4: Selecting the jacking force

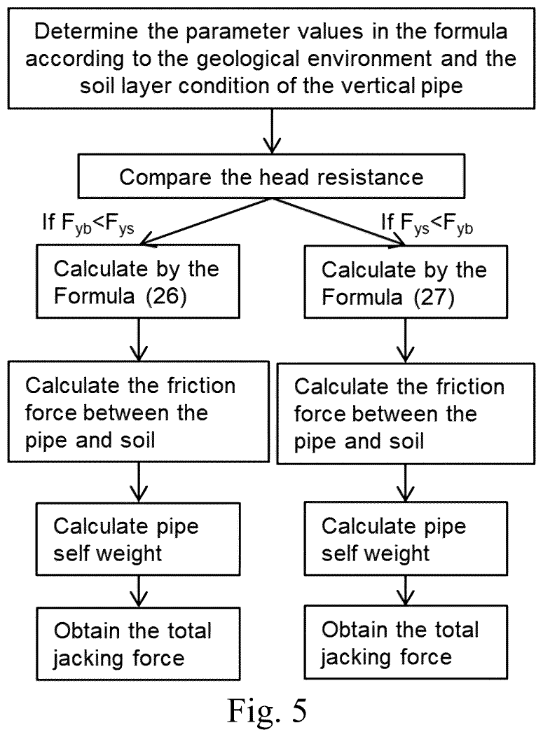

In this way, a reasonable jacking force prediction calculation system is obtained; the jacking force can be calculated only by knowing the position of the vertical pipe, soil layer parameters, the size of the vertical pipe and other parameters; and the specific solving flowchart is shown in FIG. 5.

If F_{yb}<F_{ys}, then:

$$F = {F}_{y b} + {F}_{f} + {G}_{p} \qquad ( 34 )$$

If F_{ys}<F_{yb}, then:

$$F = {F}_{y s} + {F}_{f} + {G}_{p} \qquad ( 35 )$$

The technical effects of the technical solutions of the present invention will be further described below with reference to specific embodiments.

A drainage project case in a certain city is selected to calculate the jacking force of the whole construction process by the jacking method. The drainage project is a tail water sea disposal pipe project of a sewage treatment plant; a road section constructed by the vertical jacking method is located between a 2#well and a B3 sewage draining port; the total length of the section is 1,420 m; the outer diameter of a horizontal tunnel is 2 m; the wall thickness is 22mm; 29 vertical pipes are jacked within the range 400 m away from the sewage draining port; the diameter of each vertical pipe is 0.5 m; the wall thickness is 20 mm; the jacking height of each vertical pipe is 12.5 m; and each vertical pipe is composed of a first pipe section with the length of 0.5 m and 20 standard pipe sections with the length of 0.6 m. In this project, the height from the sea level to the mud surface line is 14.41 m, and the distance from the mud surface line to the upper side of the horizontal tunnel is 11.5 m.

According to the condition that vertical pipes penetrate through soil, the vertical pipes can be divided into two groups, the first group of vertical pipes penetrate through a single soil layer, and the second group of vertical pipes penetrate through a plurality of soil layers; 5 vertical pipes, including 3 vertical pipes with the most representative jacking force in the first group of vertical pipes and 2 vertical pipes in the second group of vertical pipes, are selected for typical calculation and analysis of the jacking force; they are the 3^{rd} vertical pipe, the 4^{th} vertical pipe and the 5^{th} vertical pipe in the first group of vertical pipes, and they are the 11^{th} vertical pipe and the 12^{th} vertical pipe in the second group of vertical pipes; and the first group of vertical pipes need to penetrate through a coarse gravel sand layer being 11.5 m and a water purification layer being 1 m. The second group of vertical pipes penetrate through a clay layer being 0.5 m, a clay layer being 11 m and a water purification layer being 1 m.

According to engineering geological reports, the coarse gravel sand soil body weight is 19.8 kN·m⁻3, the cohesive force is 0, the internal friction angle is 41.9 41.9°, the compression modulus is 46 MPa, the clay weight is 19.6 kN.m⁻³, the cohesive force is 47.4 kPa, the internal friction angle is 13.2°, and the compression modulus is 12 MPa.

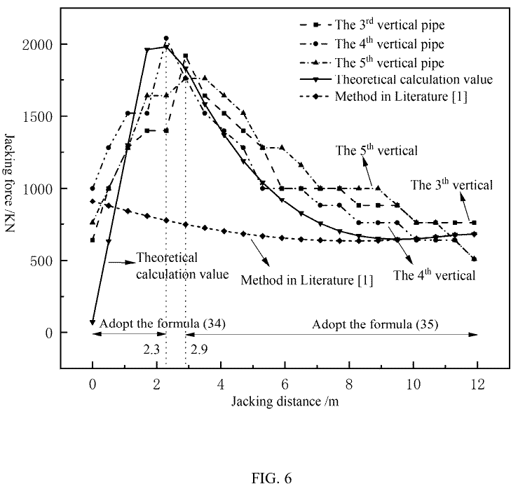

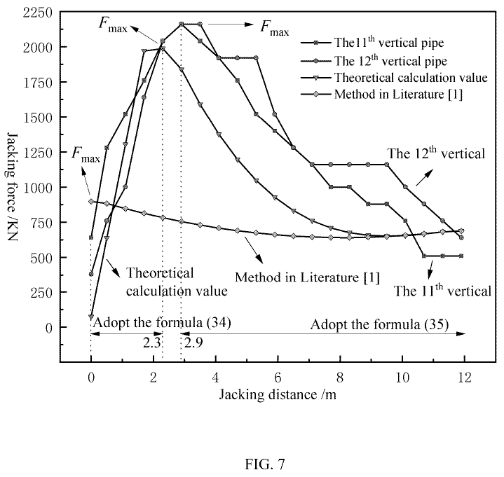

The radius Rₚ of the plastic zone is calculated through Formulas (13)-(21), and then is substituted into Formula (26); the Formula (26) is compared with the Formula (27) to obtain the head resistance; Formulas (32) and (33) are used for calculating to obtain frictional resistance between the pipe soil and the pipe self weight; and according to Formulas (34) and (35), a calculated jacking force value of the vertical pipe in the process of constructing by the vertical jacking method is obtained. In order to better evaluate the correctness of a theoretical calculation method, the measured values of 2 groups of vertical pips are compared with a theoretical calculation result and a current mainstream calculation method result; the comparison chart of jacking force results of the first group of vertical pipes is shown in FIG. 6; and a comparison chart of jacking force results of the second group of vertical pipes is shown in FIG. 7. In addition, for maximum jacking force most concerned in the project, calculation results of different algorithms are shown in Table 1.

TABLE 1
Comparison of maximum jacking forces for different algorithms

| | | Calculated | | | |
|---|---|---|---|---|---|
| | Measured | value of the | | | |
| | average | present | | Literature | Literature |
| Group | value/(kN) | invention/(kN) | Specification/(kN) | [4]/(kN) | [5]/(kN) |
| The first | 1906.7 | 1981.5 | 862 | 412.8 | 473.7 |
| group | | | | | |
| The | 2160 | 1987.6 | 809.5 | 218.1 | 475.4 |
| second | | | | | |
| group | | | | | |

Literatures cited in the present invention are as follows:

Literature [1] Wang Shousheng, Ge Chunhui. Discussion on calculation method of vertical pipe jacking [J]. Special Structures, 2009, 26 (5): 18-21.

Literature [2] DG/TJ 08-2049-2016 Code for Construction of Pipe Jacking Engineering [S]. Tongji University Press, 2017.

Literature [3] Carter J P, Booker J R, Yeung S K. Cavity expansion in cohesive frictional soils [J]. Geotechnique, 1986, 36 (3): 349-358.

Literature [4] Dong Shengxian, Luo Shuqing. Application of vertical jacking method in power plant intake and drainage tunnel engineering [J]. Electric Power Survey & Design, 2012 (6): 47-51.

Literature [5] Liu Guirong. Research on construction technology of water intake structure of large nuclear and thermal power plants [D]. Shanghai Jiao Tong University, 2014.

As shown in FIG. 6, before the jacking distance is 2.3 m, F_{yb}<F_{ys}, Formula (34) is adopted for calculation; and after the jacking distance is 2.9 m and higher, F_{ys}<F_{yb}, Formula (35) is adopted for calculation. The maximum jacking forces of the first group of vertical pipes are 1920 kN, 2040 kN, 1760 kN, and the average value is 1906.7 kN; the theoretical calculation value according to the present invention is 1,981.5 kN, the theoretical value is large, and the difference is 3.9%, the final jacking forces are 760 kN, 510 kN, 510 kN respectively, and the average value is 593.3kN; the theoretical calculation value according to the present invention is 681.7 kN, the theoretical value is large, and the difference is 14.9%.

As shown in FIG. 7, before the jacking distance is 2.3 m, F_{yb}<F_{ys}, Formula (34) is adopted for calculation; and after the jacking distance is 2.9 m and higher, F_{ys}<F_{yb}, Formula (35) is adopted for calculation. The maximum jacking force of the second group of vertical pipes is 2,160 kN; the theoretical calculation value according to the present invention is 1,987.5 kN; the measured value is large, the difference is 8%; the final jacking forces are 510 kN and 640 kN respectively, and the average value is 575 kN; and the theoretical calculation value according to the present invention is 688.2 kN, the theoretical value is large, and the difference is 19.7%.

As shown in FIG. 6 and FIG. 7, in actual project, not the first pipe section has the maximum jacking force, and the jacking force is subjected to a two-section type change of increasing and then decreasing; the positions where the maximum jacking force occurs are at parts of 2.9 m, 2.3 m and 2.9 m in the first group, the average value is 2.7 m (0.235H); the position where the maximum jacking force occurs is at a part of 2.9 m (0.252 H); and the theoretical method calculation values according to the present invention are all 2.3 m (0.2 H).

In addition, for the maximum jacking force most concerned in the project, it can be seen from Table 1 that the calculation result of the calculation method is closest to the actual value, which indicates that the derived calculation formula is well matched with the project.

This project example shows that the present invention is based on a spherical hole expansion method basic solution and a shear failure theory, the influence of the dynamic change of the thickness of the overlying soil on head resistance is considered, and theoretical reference can be provided for the jacking force calculation method for the whole construction process by the vertical jacking method.

1. A jacking force prediction method for a whole construction process by a vertical jacking method, comprising the following steps:
step 1, determining a component part of a jacking force in constructing by the vertical jacking method;
the jacking force F of the vertical jacking method is matched according to the three parts, namely, a head resistance F_{y}, a friction force F_{f} between a pipe and soil and the pipe self weight Gₚ; the head resistance F_{y} is the sum of stress at a vertical pipe cover, namely, F=F_{yp}+F_{f}+Gₚ;
step 2, selecting a stress model in the jacking process of the vertical pipe, and calculating the head resistance F_{y};
according to the thickness of an overlying soil layer, the stress of head resistance is divided into two stress models, namely a spherical hole expansion-sliding friction model and a shear failure-sliding friction model; when the overlying soil layer is higher, and if F_{yb}<F_{ys}, a spherical hole expansion problem occurs at the vertical pipe cover, then F_{y}=F_{yb}=πPᵤ R_{d}²; and when the overlying soil layer is lower, and if F_{ys}<F_{yb}, a soil body failure form at the vertical pipe cover is shear failure, and then F_{y}=F_{ys}=Gₛ+G_{w}+F4; Gₛ represents soil weight (kN) in a shear failure line, Gₛ=γ′πh[R_{d}²+Rₘ²+R_{d}Rₘ]/3 and Rₘ=Rₐ+htan(45°−Φ/2); G_{w} represents water weight (kN) in the range of the vertical pipe, G_{w}=γ_{w}πR_{d}²H; F_{cf} represents resistance (kN) caused by the cohesive force of the soil body in the shear failure line, F_{cf}=cπ(R_{d}+Rₘ)\sqrt{(Rₘ−R_{d})²+h²}; and F_{yb} represents head resistance (kN) under a spherical hole expansion-sliding friction model; F_{ys} Pu represents head resistance (kN) under a shear failure-sliding friction model; Pᵤ represents ultimate reaming pressure (kPa); R_{d} represents the radius (m) of the vertical pipe; γ′ represents effective weight (kN·m⁻³) of the soil body; h represents the height (m) from the vertical pipe pipe cover to a mud surface line; Rₘ represents distance (m) from the shear failure line extending to the mud surface line to the center of the vertical pipe; γ_{w} represents water weight (kN·m⁻³); H represents height (m) from the upper side of a horizontal tunnel to the mud surface line; and c represents cohesive force (kPa);
step 3, calculating the jacking force according to the calculated F=F_{y}+F_{f}+Gₚ.

2. The jacking force prediction method for a whole construction process by a vertical jacking method according to claim 1, wherein the value of the friction force Fr between the pipe and soil is calculated to the formula: according following formula: F_{f}=μKπDL²[γ′h+γ_{w}h_{w}+γ_{w}(H+h)/2], μ represents a friction coefficient between the pipe and the soil, K represents lateral soil pressure coefficient, and D represents outer diameter (m) of the vertical pipe.

3. The jacking force prediction method for a whole construction process by a vertical jacking method according to claim 1, wherein the value of self weight Gₚ of the pipe is calculated according to the following formula: Gₚ=nG′; n represents the number of jacked pipe sections; and G′ represents average self weight (kN) of the pipe sections.
